(19) United States
(12) Patent Application Publication
(10) Pub. No.: US 2009/0212512 A1
(43) Pub. Date: Aug. 27, 2009

(54) Method and device for increasing the driving stability of motor vehicles

(76) Inventor: Markus Hoermann, Mietingen (DE)

Correspondence Address: FLYNN THIEL BOUTELL & TANIS, P.C., 2026 RAMBLING ROAD, KALAMAZOO, MI, 49008-1631, US

(21) Appl. No.: 11/919,948

(22) PCT Filed: Apr. 12, 2006
(86) PCT No.: PCT/EP2006/003339

§ 371 Date: Dec. 22, 2008

(30) Foreign Application Priority Data
May 4, 2005 (DE) 10 2005 021 887.3

(51) Int. Cl. B60G 13/08; B60P 3/00

(52) U.S. Cl. 280/6.159

(57) ABSTRACT

The invention relates to a method and device for increasing the driving stability of motor vehicles (PB), comprising a hydraulically-operated device support (GT) for mounting a working device (FS). According to the invention, the device support (GT) is controlled at a given set position, whereby an actuating parameter for the positional control (PR) is given in the form of a hydraulic pressure set value and a hydraulic pressure is regulated to the given hydraulic pressure set value, whereby a stabilizing time for the pressure regulation is much smaller than a stabilizing time for the positional regulation. Said device comprises a position regulator (PR) for positional regulation of the device support (GT), whereby an actuating parameter of the position regulator (PR) is given in the form of a hydraulic pressure set value and a pressure regulator (RE) is coupled to the position regulator (PR) to regulate the hydraulic pressure to the given hydraulic pressure set value. The above is of application, for example, in snow piste-bashing machines.

The invention relates to a method and to a device for increasing the driving stability of motor vehicles which have a hydraulically driven implement carrier for holding a working implement.

Vehicles having an implement carrier for coupling or holding various working implements, for example snow piste preparation vehicles having an implement carrier for coupling a rotary snow plough, fire trucks having an implement carrier for coupling or holding a ladder or tractors having an implement carrier for holding a plough, often have a low level of driving stability when the working implement is coupled on, since the working implement which is coupled to the implement carrier leads to an unfavorable weight distribution, as a result of which an undesired unloading of a front or rear region of the motor vehicle, and unstable oscillation of the motor vehicle, can be caused for example in the event of bumps in the roadway or underlying surface.

In order to increase the driving stability, so-called active vibration damping systems are known in the case of agricultural machines or tractors. In said systems, the implement carrier is placed into a defined transport position when the working implement is moved out of its working position. When the desired transport position is reached, the implement carrier is hydraulically locked, that is to say the implement carrier and the working implement which is coupled thereto can no longer leave the transport position. The hydraulic locking is brought about by closing a hydraulic circuit, that is to say a pressure compensation or pressure dissipation can take place in a hydraulic drive. If the motor vehicle travels over a bump in the roadway, the force on the implement carrier increases on account of the inertial force acting on the working implement. The force acting on the implement carrier is measured by means of force sensors. If the measured force increases, a deviation of the implement carrier out of its transport position can, above a certain threshold value, be desirable in order to increase driving stability. For this purpose, the hydraulic locking is briefly interrupted by opening a valve. By opening the valve, the hydraulic force decreases, thereby causing a movement of the implement carrier in the direction of the force action. In this way, force peaks which are caused by the working implement and are conducted into the implement carrier and therefore into the vehicle are reduced, thereby improving the driving behavior and decreasing vehicle wear. When the measured force decreases again to a predetermined value, the transport position can be resumed again and the system can be hydraulically locked again.

In order to obtain a satisfactory improvement in driving dynamics, the lowest possible reaction time to a force introduction is however necessary. For this purpose, the relevant components, that is to say the force sensors, the valve and an associated control unit, must permit regulation practically in real-time. Such components are highly complex and are therefore correspondingly expensive. In addition, the force. measurement is susceptible to faults, thereby hindering reliable operation.

The invention is based on the technical problem of providing a method and a device for increasing the driving stability of motor vehicles which have a hydraulically driven implement carrier, which method and device can be realized in a simple and cost-effective manner and at the same time ensure a high level of driving safety.

The invention solves said problem by providing a method having the features of claim 1 and a device having the features of claim 6. Advantageous and preferred embodiments of the invention are the subject matter of the further claims and are explained in more detail below. The wording of the claims is, by express reference, included in the content of the description. Some of the features and properties listed below relate both to the method and to the device. They are in part described only once, but are applicable independently of one another both to the method and also to the device.

According to the invention, the implement carrier is adjusted into a predefinable nominal position in a regulated fashion, with an actuating variable of the position regulation being output in the form of a hydraulic pressure nominal value. The hydraulic pressure is adjusted to the output hydraulic pressure nominal value in a regulated fashion, with a settling time of the pressure regulation being significantly shorter than a settling time of the position regulation. The settling time is to be understood to mean that time duration after which a magnitude of a regulating deviation is smaller than a predefinable limit. The vibration damping accordingly takes place with two nested or cascaded regulating circuits of different speed, with the superordinate regulating circuit providing position regulation of the implement carrier, and the subordinate regulating circuit providing pressure regulation. The actuating variable output of the superordinate position regulating circuit is a predefined nominal value of the subordinate pressure regulating circuit. On account of the shorter settling time of the pressure regulation, the implement carrier compresses in the event of force shocks, for example on account of bumps in the roadway, since the position regulator firstly reacts in a comparatively delayed fashion to the position change of the implement carrier caused by the compression. This results in a direct absorption of a force introduction caused by the working implement, as a result of which the driving stability is improved and the vehicle wear is reduced. The position regulation subsequently approaches the transport position again after a time delay. Since conventional pressure regulators with small time constants can be used for pressure regulation and conventional position regulators can be used for position regulation, the vibration damping or driving stability improvement can be realized using standard components, without fast and therefore expensive regulators and force sensors being required. In contrast to the conventional method, the hydraulic activation is accordingly not locked or closed and opened only in the event of a hard-to-measure force exceedance, but rather opens automatically on account of the pressure regulation when the force and therefore the pressure increases. This is therefore a hydraulically open system.

In one refinement of the method, the position is regulated with a PI-regulator or a PID-regulator. Regulators of said type have good stationary and dynamic regulating properties. For example, with both regulator types, there is no remaining regulating difference, that is to say a stationary deviation between nominal value and actual value. In addition, the dynamic properties, for example the settling time, can be set be means of a suitable selection of the P, I and D components.

In one refinement of the method, the hydraulic pressure is regulated with an electrically proportional pressure regulating valve, and the actuating variable of the position regulator is provided in the form of an electric activation signal for the pressure regulating valve. This permits a cost-effective coupling of a control unit which performs the position regulation with the pressure regulating valve.

In one refinement of the method, the position of the implement carrier or of the working implement is measured with a rotational angle sensor. In this way, it is possible in the case of rotatably or pivotably mounted implement carriers to carry out a position determination in a simple manner on the basis of an angle determination.

In one refinement of the method, the settling time of the position regulation is at least three times as long as the settling time of the pressure regulation. The ratio of the settling times determines inter alia the magnitude of the deflection of the implement carrier in the event of a force introduction into the implement carrier. If both settling times, at least theoretically, are arbitrarily short, then a cushioning of the implement carrier no longer takes place, since a position change is compensated directly by a pressure change. If the settling time of the position regulation is very long in comparison to the settling time of the pressure regulation, the position variation of the implement carrier in the event of a force introduction is relatively large. The ratio is accordingly to be selected inter alia as a function of the implement carrier position, the implement carrier mass and the vehicle mass in such a way as to set a satisfactory driving stability.

The device according to the invention comprises a position regulator for the position regulation of the implement carrier, with an actuating variable of the position regulator being output in the form of a hydraulic pressure nominal value, and a pressure regulator which is coupled to the position regulator for adjusting a hydraulic pressure to the output hydraulic pressure nominal value in a regulated fashion.

In one refinement of the device, the latter comprises a PI-regulator or a PID-regulator for position regulation.

In one refinement of the device, the pressure regulator is an electrically proportional pressure. regulating valve.

In one refinement of the device, the latter comprises a rotational angle sensor for measuring the position of the implement carrier.

In one refinement of the device, the latter comprises a hydraulic cylinder for driving the implement carrier.

An advantageous exemplary embodiment of the invention is illustrated schematically in the drawings and is described below. In the drawings:

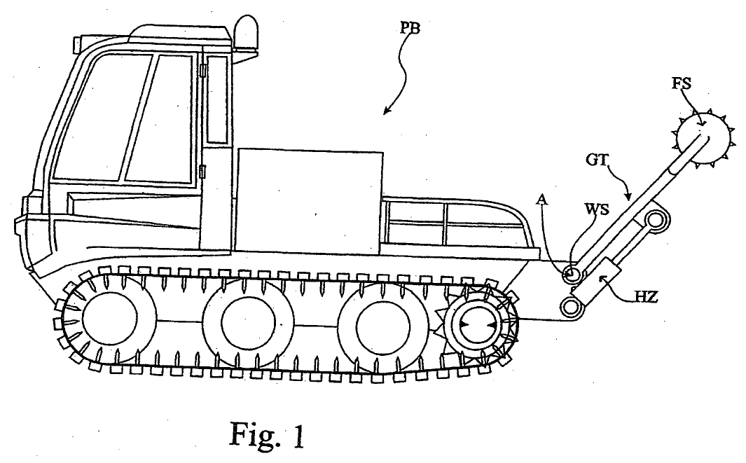

FIG. 1 is an illustration of a snow piste preparation vehicle having an implement carrier which is driven by a hydraulic cylinder and is coupled to a rotary plough,

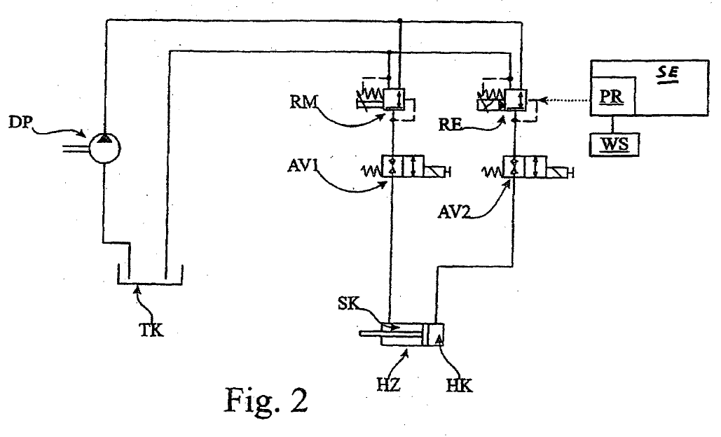

FIG. 2 shows a block circuit diagram of an activation unit of the hydraulic cylinder having a hydraulic circuit and having an associated control unit.

FIG. 1 is a simplified illustration of a snow piste preparation vehicle PB. having an implement carrier GT which is rotatable about an axis A and is hydraulically driven by a hydraulic cylinder HZ and is coupled to a working implement in the form of a rotary plough FS. The position of the implement carrier GT is measured by means of an angle sensor WS. When the rotary plough FS is not positioned in a lowered, working position, it is moved, as shown in FIG. 1, into a transport position. On account of the resulting unfavorable center of gravity position, the driving stability of the piste groomer PB is considerably reduced, in particular when traveling over bumps.

In order to increase the driving stability, the hydraulic cylinder Hz is activated such that the rotary plough FS can perform a defined vertical compensating movement when traveling over bumps in the ground.

FIG. 2 shows a block circuit diagram of an activation unit of the hydraulic cylinder HZ from FIG. 1 having a hydraulic circuit and having an associated control unit SE. The hydraulic circuit comprises a pressure regulating pump DP for generating a working pressure, a tank TK with hydraulic oil, a first activating valve AV1, a second activating valve AV2, a first pressure regulator in the form of a mechanical pressure regulating valve RM, a second pressure regulator in the form of an electric pressure regulating valve RE, and the hydraulic cylinder HZ already shown in FIG. 1.

The pressure regulating pump DP extracts hydraulic oil from the tank TK and feeds said hydraulic oil with working pressure into the pressure regulating valves RM and RE. The pressure regulating valves RM and RE conduct a certain quantity of hydraulic oil back into the tank TK as a function of pressure conditions. Connected between an outlet of the pressure regulating valve RM and a lowering chamber SK of the hydraulic cylinder HZ is the activating valve AV1 which is closed when the vehicle is switched off. Connected between an outlet of the pressure regulating valve RE and a lifting chamber HK of the hydraulic cylinder HZ is the activating valve AV2 which is closed when the vehicle PB is switched off and accordingly, in combination with the activating valve AV1, provides locking of the implement carrier GT.

The pressure regulating valve RM acts on the lowering chamber SK of the hydraulic cylinder HZ with a constant, adjustable pressure, as a result of which a lowering of the implement carrier GT is possible in any position of the vehicle PB, for example even when traveling down a steep piste, since in the event of a reduction in the pressure in the lifting chamber HK, a pressure difference is set between the lifting chamber HK and the lowering chamber SK, which pressure difference brings about a lowering movement of the implement carrier GT.

The control unit SE comprises, in addition to other components which are not shown, a position regulator PR for the position regulation of the implement carrier GT, which position regulator PR is configured as a PI- or PID-regulator. For position measurement, the control unit SE or the position regulator PR is coupled to the angle sensor WS, with it being possible for the position of the implement carrier GT to be calculated from the measured rotational angle.

The position regulator PR is coupled to the electric pressure regulating valve RE, with an actuating variable of the position regulator PR being output in the form of a voltage which serves as an activation signal or as a predefined nominal value for the pressure regulating valve RE. The pressure regulating valve RE acts on the lifting chamber HK of the hydraulic cylinder HZ with a pressure which is proportional to the voltage output by the position regulator PR. The implement carrier GT is raised or lowered, or remains in its present position, as a function of a pressure difference between the lifting chamber HK and the lowering chamber SK and the force of gravity acting on the implement carrier GT.

If the position measured by the angle sensor WS correlates with the nominal position predefined in the position regulator PR, the latter holds its actuating variable constant, that is to say the pressure regulating valve RE likewise holds its output pressure constant. If a position is measured which is too low in the vertical direction, the position regulator PR increases its actuating variable and therefore the nominal value for the pressure regulating valve RE. The pressure regulating valve RE accordingly increases its output pressure until the desired position is reached. If a position is measured which is too high in the vertical direction, the position regulator PR reduces its actuating variable and therefore the nominal value for the pressure regulating valve RE. The pressure regulating valve RE accordingly reduces its output pressure until the desired position is reached.

If the vehicle, when the implement carrier GT is in a stable position, travels over a bump in the roadway, an inertial force acts on the rotary plough FS, for example downward in the vertical direction. Since the pressure regulating valve RE operates substantially without a delay, a pressure rise, which is caused by the inertial force, at the outlet of the pressure regulating valve RE is dissipated by discharging hydraulic oil into the tank, that is to say the pressure regulating valve RE seeks initially to give a constant output pressure. Since the force, which is caused by the hydraulic pressure or the hydraulic cylinder HZ, on the implement carrier GT and the force of gravity and inertial force on the latter caused by the rotary plough are no longer in equilibrium, the implement carrier GT moves downward in the vertical direction. The implement carrier can accordingly deviate downward, and dissipates the vibration energy into the hydraulic oil.

Said position variation is measured by the angle sensor WS, whereupon the position regulator PR adjusts the actual position to the nominal position in a regulated fashion by increasing the actuating variable or the output pressure of the pressure regulating valve RE. Said process takes place dynamically, with a vibration amplitude of the implement carrier being dependent on the inertial force acting on the rotary plough FS and the settling speed of the position regulator PR or the ratio of the settling times of the position regulator PR and the settling time of the pressure regulating valve RE.

The exemplary embodiment shown permits an effective and reliable damping of vibrations and increase in driving stability of the piste groomer without complex and expensive special components being required for this purpose.

In the exemplary embodiment shown, the motor vehicle is a snow piste preparation vehicle having an implement carrier which is arranged on the rear side and is coupled to a rotary plough. The implement carrier can of course also be arranged on the front side and carry for example a snow plough. The motor vehicle can for example also be an agricultural machine, to the implement carrier of which can be coupled any desired working implement.

1. A method for increasing the driving stability of motor vehicles (PB) which have a hydraulically driven implement carrier (GT) for holding a working implement (FS), having the steps
adjusting the implement carrier (GT) into a predefinable nominal position in a regulated fashion, with an actuating variable of the position regulation being output in the form of a hydraulic pressure nominal value, and
adjusting a hydraulic pressure to the output hydraulic pressure nominal value in a regulated fashion, with a settling time of the pressure regulation being significantly shorter than a settling time of the position regulation.

2. The method as claimed in claim 1, characterized in that the position is regulated with a PI-regulator or a PID-regulator.

3. The method as claimed in claim 1, characterized in that the hydraulic pressure is regulated with an electrically proportional pressure regulating valve (RE), and the actuating variable of the position regulation is provided in the form of an electric activation signal for the pressure regulating valve (RE).

4. The method as claimed in claim 1, characterized in that the position of the implement carrier is measured with a rotational angle sensor (WS).

5. The method as claimed in claim 1, characterized in that the settling time of the position regulation is at least three times as long as the settling time of the pressure regulation.

6. A device for increasing the driving stability of motor vehicles (PB), in particular for carrying out the method as claimed in claim 1, which have a hydraulically driven implement carrier (GT) for holding a working implement (FS), having
a position regulator (PR) for the position regulation of the implement carrier (GT), with an actuating variable of the position regulator (PR) being output in the form of a hydraulic pressure nominal value, and
a pressure regulator (RE) which is coupled to the position regulator (PR) for adjusting the hydraulic pressure to the output hydraulic pressure nominal value in a regulated fashion.

7. The device as claimed in claim 6, characterized by a PI-regulator or a PID-regulator for position regulation.

8. The device as claimed in claim 6, characterized in that the pressure regulator is an electrically proportional pressure regulating valve (RE).

9. The device as claimed in claim 6, characterized by a rotational angle sensor (WS) for measuring the position of the implement carrier (GT).

10. The device as claimed in claim 6, characterized by a hydraulic cylinder (HZ) for driving the implement carrier (GT).
